(19) United States
(12) Patent Application Publication
(10) Pub. No.: US 2014/0064567 A1
(43) Pub. Date: Mar. 6, 2014

(54) APPARATUS AND METHOD FOR MOTION ESTIMATION IN AN IMAGE PROCESSING SYSTEM

(71) Applicant: Samsung Electronics Co., Ltd., Suwon-si (KR)

(72) Inventors: Seung-Gu KIM, Seoul (KR); Se-Hyeok PARK, Seoul (KR); Tae-Gyoung AHN, Yongin-si (KR)

(73) Assignee: Samsung Electronics Co., Ltd., Suwon-si (KR)

(21) Appl. No.: 14/013,650

(22) Filed: Aug. 29, 2013

(30) Foreign Application Priority Data
Aug. 29, 2012 (KR) 10-2012-0094954

(51) Int. Cl. G06T 7/20

(52) U.S. Cl. CPC G06T 7/2086
USPC 382/107

(57) ABSTRACT

An apparatus and method for motion estimation apparatus in an image processing system are provided. A depth information detector detects depth information relating to an input image on the basis of a predetermined unit. An image reconfigurer separates objects included in the input image based on the detected depth information and generates an image corresponding to each of the objects. A motion estimator calculates a motion vector of an object in each of the generated images, combines the motion vectors of the objects calculated for the generated images, and outputs a combined motion vector as a final motion estimate of the input image.

### PRIORITY

This application claims priority under 35 U.S.C. §119(a) to a Korean Patent Application filed in the Korean Intellectual Property Office on Aug. 29, 2012 and assigned Serial No. 10-2012-0094954, the contents of which are incorporated herein by reference, in its entirety.

### BACKGROUND

1. Field

The inventive concept relates to an apparatus and method for motion estimation in an image processing system.

2. Description of the Related Art

Conventionally, the motion of an image (a motion of objects forming an image based on the relationship between previous and next frames) is estimated by comparing a plurality of previous and next images along a time axis on a two-dimensional (2D) plane. More specifically, one image is divided into smaller blocks and the motion of each block is estimated by comparing a current video frame with a previous or next video frame.

A shortcoming with the conventional motion estimation method is that a motion estimation error frequently occurs at the boundary between objects having different motions. The reason is that although a plurality of objects have three-dimensional (3D) characteristics, i.e., depth information that make the objects look protruding or receding, when motion estimation is performed in the conventional motion estimation method, the motion estimation is only based on the two-dimensional information.

Accordingly, there exists a need for a method for more accurately performing motion estimation, by reducing a motion estimation error in an image.

### SUMMARY

An aspect of exemplary embodiments of the inventive concept is to address at least the problems and/or disadvantages and may provide at least the advantages which are described below. Accordingly, an aspect of exemplary embodiments of the inventive concept is to provide an apparatus and method for more precisely estimating a motion in an image processing system.

Another aspect of exemplary embodiments of the inventive concept is to provide an apparatus and method which more accurately estimates the motion of each object in an image, by using depth information.

A further aspect of exemplary embodiments of the inventive concept is to provide an apparatus and method for increasing the accuracy of motion estimation while using a simplified structure in an image processing system.

In accordance with an exemplary embodiment of the inventive concept, there is provided a motion estimation apparatus in an image processing system, in which a depth information detector detects depth information relating to an input image on a predetermined unit basis. An image reconfigurer separates objects included within the input image based on the detected depth information and generates an image corresponding to each of the objects. A motion estimator calculates a motion vector of an object within each of the generated images, combines motion vectors of the objects calculated for the generated images, and outputs a combined motion vector as a final motion estimate of the input image.

In accordance with another exemplary embodiment of the inventive concept, there is provided a motion estimation method in an image processing system, in which depth information relating to an input image is detected on a predetermined unit basis, objects included in the input image are separated based on the detected depth information, an image corresponding to each of the objects is generated, a motion vector is calculated for an object in each of the generated images, motion vectors of the objects calculated for the generated images are combined, and a combined motion vector is output as a final motion estimate of the input image.

### BRIEF DESCRIPTION OF THE DRAWINGS

The above and other objects, features and advantages of certain exemplary embodiments of the inventive concept will be more apparent from the following detailed description taken in conjunction with the accompanying drawings, in which:

FIGS. 1A and 1B illustrate a motion of an object between previous and next frames in an image;

FIG. 2 illustrates a general motion estimation apparatus;

FIGS. 3A and 3B illustrate exemplary images reconfigured to have a plurality of layers according to an exemplary embodiment of the inventive concept;

FIG. 4 is a block diagram of a motion estimation apparatus in an image processing system according to an exemplary embodiment of the inventive concept;

FIG. 5 illustrates an operation for reconfiguring an image using depth information according to an exemplary embodiment of the inventive concept;

FIG. 6 illustrates an operation for combining images of a plurality of layers according to an exemplary embodiment of the inventive concept;

FIG. 7 illustrates a motion estimation operation in the image processing system according to an exemplary embodiment of the inventive concept; and

FIG. 8 is a flowchart illustrating an operation of the motion estimation apparatus in the image processing system according to an exemplary embodiment of the inventive concept.

Throughout the drawings, the same drawing reference numerals will be understood to refer to the same elements, features and structures.

### DETAILED DESCRIPTION OF THE EXEMPLARY EMBODIMENTS

Reference will be made to preferred exemplary embodiments of the inventive concept with reference to the attached drawings. A detailed description of a generally known function and structure of the inventive concept will be avoided lest it should obscure the subject matter of the inventive concept. In addition, although the terms used in the inventive concept are selected from generally known and used terms, the terms may be changed according to the intention of a user or an operator, or customs. Therefore, the inventive concept must be understood, not simply by the actual terms used but by the meanings of each term lying within.

The inventive concept provides an apparatus and method for performing motion estimation in an image processing system. Specifically, depth information is detected from a received image on the basis of a predetermined unit. Objects included in the received image are separated based on the detected depth information. An image which corresponds to each separated object is generated. The motion vector is calculated for the object in the generated image, and the motion vectors of the images generated for the objects are combined and output as a final motion estimate of the received image.

Before describing the exemplary embodiments of the inventive concept, a motion estimation method and apparatus in a general image processing system will briefly described below.

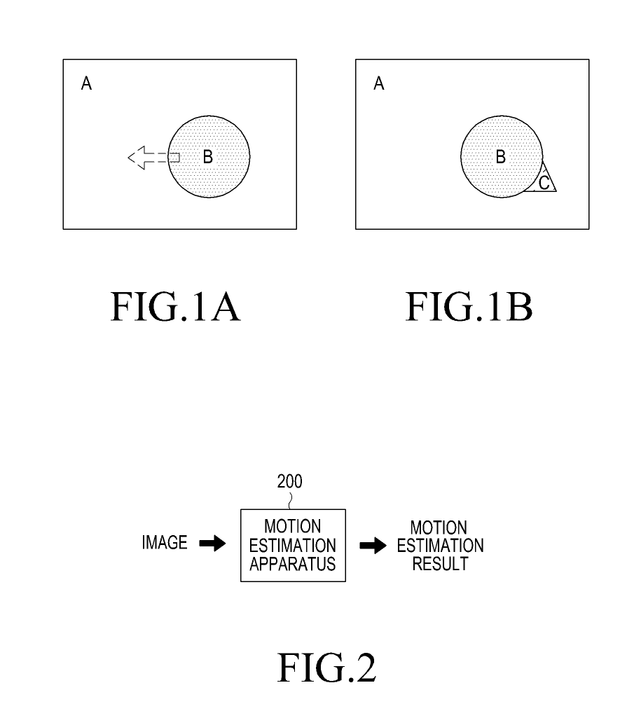

FIGS. 1A and 1B illustrate a motion of an object between previous and next frames in an image.

In the illustrated case of FIGS. 1A and 1B, by way of an example, an image includes a foreground (plane B, referred to as “object B”) and a background (plane A, referred to as “object A”).

Referring to FIG. 1A, object B may move to the left, while object A is kept stationary during a first frame. Then along with the movement of object B, a new object (referred to as “object C”) hidden behind object B may appear in a second frame next to the first frame, as illustrated in FIG. 1B.

Although object C should be considered to be a part of object A (i.e. a new area of the background), a general motion estimation apparatus 200 as illustrated in FIG. 2 erroneously determines object C to be a part of object B because it estimates the motion of each object without information about three-dimensional (3D) characteristics of the object. The motion estimation error may degrade the quality of an output from a higher-layer system (i.e. an image processing system) using a motion estimation result, which represents the quality of a final output image.

To avoid the above problem, motion estimation is performed by reconfiguring a two-dimensional (2D) image having a single layer into a plurality of images based on depth information in an exemplary embodiment of the inventive concept. For example, one 2D image may be divided into a plurality of blocks (pixels or regions) and configured into images of a plurality of images based on depth information relating to the blocks.

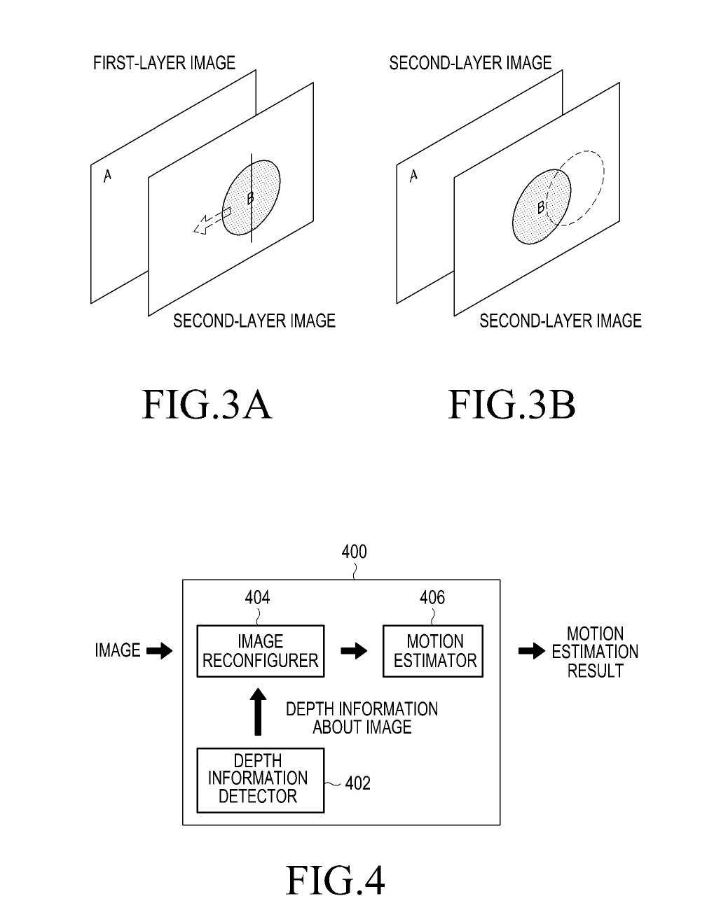

FIGS. 3A and 3B illustrate exemplary images reconfigured to have a plurality of layers according to an exemplary embodiment of the inventive concept. FIG. 3A illustrates an example of reconfiguring an image illustrated in FIG. 1A into images of a plurality of layers and FIG. 3B illustrates an example of reconfiguring an image illustrated in FIG. 1B into images of a plurality of layers.

In FIGS. 3A and 3B, object A and object B are distinguished according to their depth information, and a first-layer image including object A and a second-layer image including object B are generated. In this case, only the motion of object A or B between frames is checked in each of the first-layer image and the second-layer image, thereby remarkably reducing a motion estimation error.

Now a description will be given of a motion estimation apparatus in an image processing system according to an exemplary embodiment of the inventive concept, with reference to FIG. 4.

FIG. 4 is a block diagram of a motion estimation apparatus in an image processing system, according to an exemplary embodiment of the inventive concept.

Referring to FIG. 4, a motion estimation apparatus 400 includes a depth information detector 402, an image reconfigurer 404, and a motion estimator 406.

Upon receipt of an image, the depth information detector 402 detects depth information relating to the received image in order to spatially divide the image. The depth information detector 402 may use methods listed in (Table 1), for example, in detecting the depth information. The depth information may be detected on the basis of a predetermined unit. While the predetermined unit may be a block, a pixel, or a region, the following description is given in the context of the predetermined unit being a block, for the sake of convenience.

TABLE 1

| Method | Description |
|---|---|
| Texture (High- | It is assumed that a region having a high texture |
| frequency) Analysis | component is a foreground (an object nearer to |
| | a viewer). |
| Geometric depth | A depth is estimated geometrically. |
| analysis | If the horizon is included in a screen, it is assumed |
| | that the depth is different in the screens above and |
| | below the horizon. For example, it is assumed that |
| | the sky is deep and the sea is shallow in depth in |
| | a screen including the sky and the sear respectively |
| | above and below the horizon. |
| Template matching | An input image is compared with a template having |
| | a known depth value and the depth of the input |
| | image is determined to be the depth value of the |
| | most similar template. |
| Histogram analysis | The luminance of a screen is analyzed. Then a |
| | larger depth value is assigned to a bright region |
| | so that the bright region appears nearer to a viewer, |
| | whereas a smaller depth value is assigned to a |
| | dark region so that the dark region appears farther |
| | from the viewer. |
| Other methods | For 2D → 3D modeling, other various methods |
| | can be used alone or in combination and as a |
| | result, depth information relating to each block of |
| | an image can be obtained. |

The depth information detector 402 may be implemented into an independent processor such as a 2D-3D converter. When depth information relating to an input image is provided in metadata, the depth information detector 402 may be an analyzer (e.g. a parser) for detecting the depth information. In this case, the depth information may be provided in metadata in the following manners.
When a broadcasting station transmits information, the station transmits depth information relating to each block of an image, in addition to transmitting the image information.
In the case of a storage medium such as a Blu-ray Disk® (BD) title, data representing depth information as well as transport streams are preserved and when needed, the data is transmitted to an image processing apparatus.
In addition, depth information is provided to an image processing apparatus using an additional B/W in various predetermined methods, for example, in addition to video data.

Upon receipt of the depth information from the depth information detector 402, the image reconfigurer 404 reconfigures a 2D 1-layer image into independent 2D images of multiple layers, based on the depth information. For instance, the image reconfigurer 404 divides a plurality of pixels into a plurality of groups according to ranges into which depth information about each pixel falls, and generates a 2D image which corresponds to each group.

When the image reconfigurer 404 outputs a plurality of 2D images, the motion estimator 406 estimates a motion vector for each of the 2D images according to a frame change. The motion estimator 406 combines motion estimation results, that is, motion vectors for the plurality of 2D images, and outputs the combined motion vector as a final motion estimation value for the received image.

Additionally, the motion estimator 406 may include a motion estimation result combiner for combining the motion vectors. On the contrary, the motion estimation result combiner (not shown) may be configured separately from the motion estimator 406.

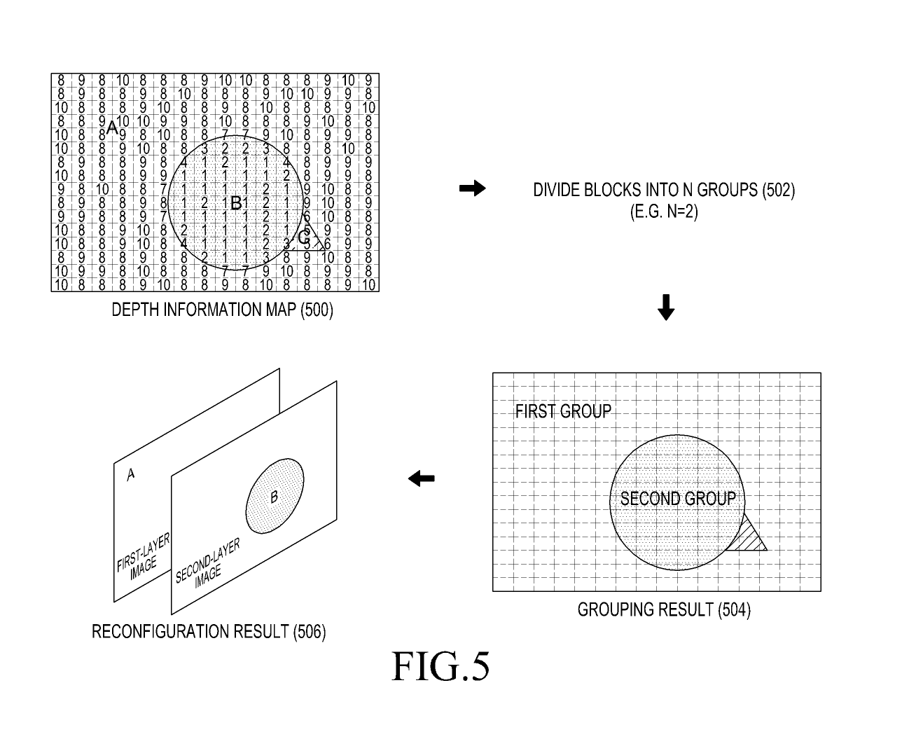

FIG. 5 illustrates an operation for reconfiguring an image using depth information, according to an exemplary embodiment of the inventive concept.

As described above, the motion estimation apparatus according to the exemplary embodiment of the inventive concept reconfigures a 2D image having a single layer into independent 2D images of multiple layers and estimates the motions of the 2D images. An operation illustrated in FIG. 5 will be described below with reference to the motion estimation apparatus illustrated in FIG. 4.

The depth information detector 402 may divide an input image into a plurality of blocks, detect depth information relating to each block, and create a depth information map 500 based on the detected depth information. For example, a depth information map is shown in FIG. 5 as representing depth information relating to each block as being between the numbers 1 to 10.

Once the depth information map 500 is created, the image reconfigurer 404 divides the blocks into a plurality of groups (N groups) according to the ranges of the depth information relating to the blocks (502). For instance, in response to the blocks being divided into two groups (N=2), the two groups may be determined according to two depth ranges.

In FIG. 5, by way of example, blocks having depth values ranging from 5 to 10 are grouped into a first group and blocks having depth values ranging from 1 to 4 are grouped into a second group. That is, object C having depth information values 5 and 6 and object A having depth information values 7 to 10 belong to the first group and object B having depth values 1 to 4 belongs to the second group.

When the blocks are divided into two groups (504), the image reconfigurer 404 generates 2D images for the two respective groups, that is, a first-layer image and a second-layer image as reconfiguration results of the input image (506). Subsequently, the motion estimator 406 estimates the motion of objects included in each of the first-layer and second-layer images, combines the motion estimation results of the first-layer image with the motion estimation results of the second-layer image, and outputs the combined result as a final motion estimation result of the input image.

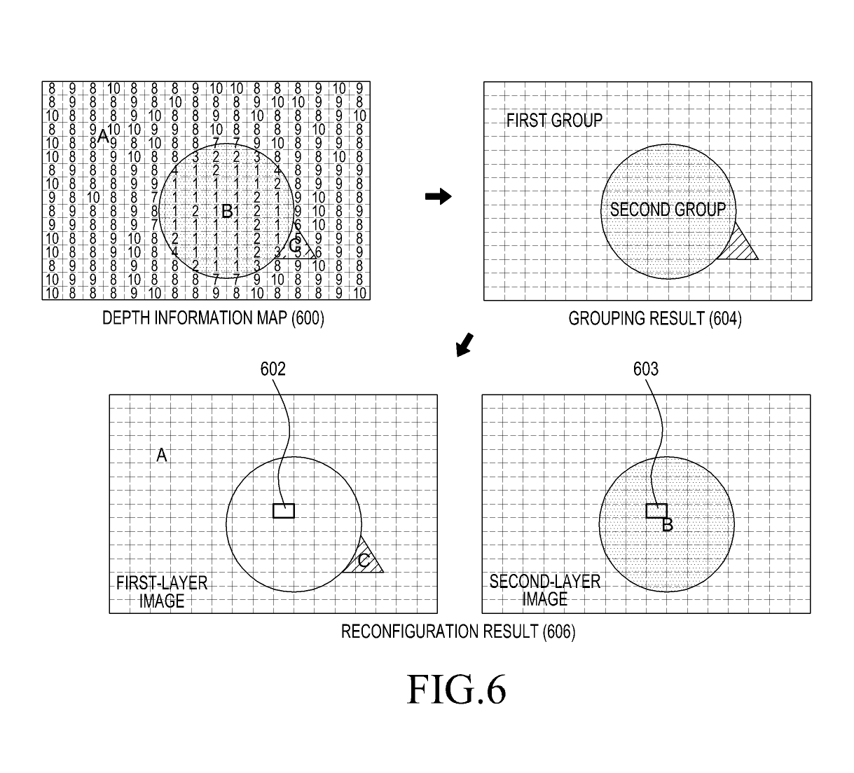

With reference to FIG. 6, a method for combining multi-layer images will be described in more detail.

FIG. 6 illustrates an operation for combining images of a plurality of layers according to an exemplary embodiment of the inventive concept.

A depth information map 600 and results 604 of grouping a plurality of blocks, illustrated in FIG. 6, are identical to the depth information map 500 and grouping results 504 illustrated in FIG. 5. Thus, a detailed description of the depth information map 600 and the grouping results 604 will not be provided herein.

Referring to FIG. 6, in response to a plurality of blocks being divided into two groups according to their depth information values, 2D images, i.e., a first-layer image and a second-layer information may be generated for the respective two groups, and then motion estimation may be performed on a layer basis. Then, the motion estimation results of the 2-layer images may be combined to thereby produce a motion estimation result of the single original image.

to combine the motion vectors of the blocks in the multiple layers, a representative (i.e., a motion vector with a highest priority) of the motion vectors of blocks at the same position in the multiple layers may be determined to be a motion vector having the lowest block matching error (e.g. the lowest Sum of Absolute Difference (SAD)).

Referring to FIG. 6, a first block 602 and a second block 603 respectively included in a first-layer image and a second-image layer shown as reconfiguration results 606, are located at the same position. However, the block matching error of the first block 602 is much larger than the block matching error of the second block 603, in the first-layer image, for the following reason. After object B marked as a solid line circle is separated from the first-layer image, the area of object B remains empty (as an information-free area). During block matching, the area of object B in the first-layer image may have a relatively large block matching error or a user may assign a maximum block matching error to the area of object B as an indication of an information-free block, according to the design.

On the other hand, the block matching error of the second block 603 is much smaller than that of the first block 602, in the second-layer image for the following reason. Pixels for block B exist at the position of the second block 603 in the second-layer image (because the area of the second block 603 is an information-having area). Therefore, the error between actual pixel values can be calculated during block matching. Accordingly, the motion vector of the second block 603 in the second-layer image is a representative motion vector of blocks at the same position as the second block 603 in the exemplary embodiment of the inventive concept illustrated in FIG. 6.

In response to blocks at the same position in the multi-layer blocks having the same or almost the same block matching error, for example, in response to the difference between the block matching errors of blocks at the same position in the multi-layer images being smaller than a predetermined threshold, the motion vector of a block having a lower depth (a foreground) is selected with priority over the motion vector of a block having a larger depth. In other words, the motion vector of a block having depth information that makes the block appear nearer to a viewer is selected as a motion vector having the highest priority representative of blocks at a given position, from among the motion vectors of blocks at the given position in the multi-layer images.

While the depth of an object appearing nearer to a viewer is expressed as “small” and the depth of an object appearing farther from the viewer is expressed as “large,” regarding depth information, depth information may be expressed in many other terms.

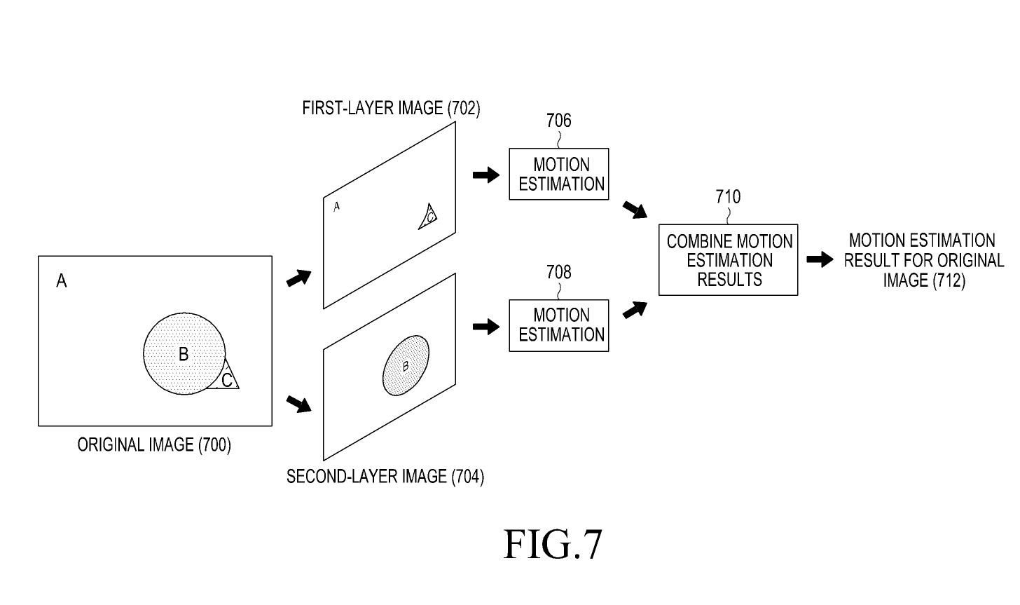

With reference to FIG. 7, a motion estimation operation in the image processing system according to an exemplary embodiment of the inventive concept will be described below.

FIG. 7 illustrates a motion estimation operation in the image processing system according to an exemplary embodiment of the inventive concept.

Referring to FIG. 7, upon receipt of a 2D image (referred to as an original image) 700, the motion estimation apparatus according to the exemplary embodiment of the inventive concept detects depth information relating to the received image. Then the motion estimation apparatus divides the original image having a single layer into a plurality of blocks and detects depth information relating to each of the blocks. The motion estimation apparatus divides the blocks into a plurality of groups based on the depth information relating to the blocks, thereby reconfiguring the original image into independent multi-layer 2D images (e.g. a first-layer image 702 and a second-layer image 704).

Subsequently, the motion estimation apparatus calculates the motion vector of an object which corresponds to each of the multi-layer 2D images on a frame basis (706 and 708) and combines the motion vectors of the multi-layer 2D images (710). The motion estimation apparatus outputs the combined value as a final motion estimation result of the original image (712).

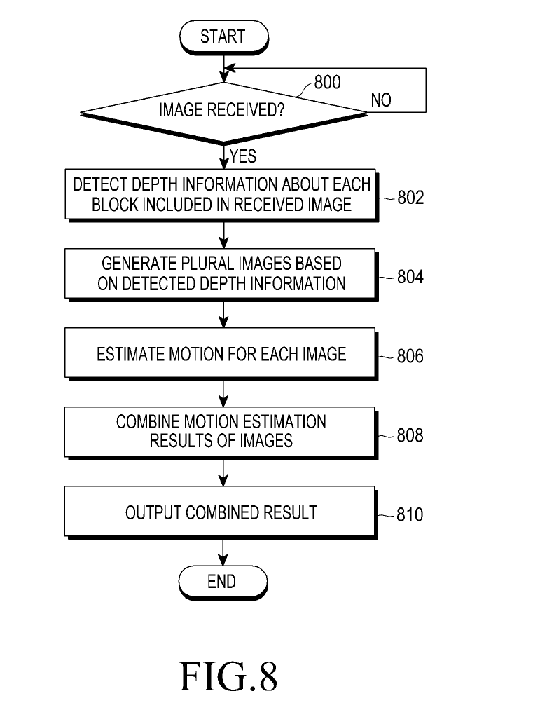

FIG. 8 is a flowchart illustrating an operation of the motion estimation apparatus in the image processing system according to an exemplary embodiment of the Inventive concept.

Referring to FIG. 8, upon receipt of an image in step 800, the motion estimation apparatus detects depth information related to each block included in the received image in step 802. In step 804, the motion estimation apparatus generates a plurality of images which correspond to a plurality of layers based on the detected depth information.

The motion estimation apparatus estimates the motion of each of the images in step 806 and combines the motion estimation results of the images in step 808. In step 810, the motion estimation apparatus outputs the combined result as the motion estimation result of the received image.

As is apparent from the above description of the inventive concept, the accuracy of motion estimation can be increased in an image processing system. In the case where a plurality of objects are overlapped in an image, the conventional problem of frequent occurrences of a motion estimation error at the boundary between objects can be overcome.

Since objects included in an image are separated, images are reconfigured for the respective objects, and motion estimation is performed independently on each reconfigured image, interference between the motion vectors of adjacent objects at the boundary between the objects can be prevented. Therefore, the accuracy of motion estimation results is increased.

Furthermore, resources required for motion estimation can be reduced. Because an original image is reconfigured into a plurality of 2D images before motion estimation takes place, motion estimation can be performed on each reconfigured 2D image with a conventional motion estimation apparatus. That is, since motion estimation of each 2D image is not based on depth information, the conventional motion estimation apparatus can still be adopted. Accordingly, the structure of a motion estimation apparatus can be simplified because a device for using 3D information in motion estimation is not needed in the motion estimation apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A motion estimation apparatus in an image processing system, the motion estimation apparatus comprising:
a depth information detector is configured to detect depth information relating to an input image on the basis of a predetermined unit;
an image reconfigurer is configured to separate objects included in the input image based on the detected depth information and generate an image corresponding to each of the objects; and
a motion estimator is configured to calculate a motion vector of an object in each of the generated images, combine motion vectors of the objects calculated for the generated images, and output a combined motion vector as a final motion estimate of the input image.

2. The motion estimation apparatus of claim 1, wherein the motion estimator combines the motion vectors of the objects in the generated images based on block matching errors of blocks included in each of the generated images.

3. The motion estimation apparatus of claim 1, wherein the depth information detector divides the input image into a plurality of blocks and detects depth information relating to each of the blocks.

4. The motion estimation apparatus of claim 3, wherein the image reconfigurer divides the plurality of blocks into at least two groups based on the depth information relating to each of the blocks and separates the objects included in the input image according to the at least two groups.

5. The motion estimation apparatus of claim 1, wherein in response to the depth information relating to the input image being received, the depth information detector includes a parser which interprets the received depth information.

6. A motion estimation method in an image processing system, the motion estimating method comprising:
detecting depth information relating to an input image on the basis of a predetermined unit;
separating objects included in the input image based on the detected depth information;
generating an image corresponding to each of the objects;
calculating a motion vector of an object within each of the generated images;
combining motion vectors of the objects calculated for the generated images; and
outputting a combined motion vector as a final motion estimate of the input image.

7. The motion estimation method of claim 6, wherein the combining comprises combining the motion vectors of the objects in the generated images based on block matching errors of blocks included within each of the generated images.

8. The motion estimation method of claim 6, wherein the detection of depth information relating to an input image comprises dividing the input image into a plurality of blocks and detecting depth information relating to each of the blocks.

9. The motion estimation method of claim 8, wherein the separation of objects included in the input image comprises dividing the plurality of blocks into at least two groups based on the depth information relating to each of the blocks and separating the objects included in the input image according to the at least two groups.

10. The motion estimation method of claim 6, wherein in response to the depth information relating to the input image being received, the depth information detection comprises parsing the received depth information to detect the depth.

11. A motion estimation apparatus comprising:
an image reconfigurer is configured to separate objects included in an input image and generates an image corresponding to each of the objects; and
a motion estimator which calculates a motion vector of an object in each of the generated images, combines and outputs the motion vectors as a final motion estimate of the input image.

12. The motion estimation apparatus of claim 11, further comprising;
a depth information detector is configured to detect depth information relating to an input image,
wherein image reconfigurer separates objects included in the input image based on
the detected depth information.

13. The motion estimation apparatus of claim 11, wherein the motion estimator combines the motion vectors of the objects in the generated images based on block matching errors of blocks included in each of the generated images.

14. The motion estimation apparatus of claim 12, wherein the depth information detector divides the input image into a plurality of blocks and detects depth information relating to each of the blocks.

15. The motion estimation apparatus of claim 14, wherein the image reconfigurer divides the plurality of blocks into at least two groups based on the depth information relating to each of the blocks and separates the objects included in the input image according to the at least two groups.

16. The motion estimation apparatus of claim 12, wherein in response to the depth information relating to the input image being received, the depth information detector comprises a parser configuring to interpret the received depth information.

17. A method of estimating motion in an image processing system, the motion estimation method comprising:
detecting depth information relating to an input image;
separating objects included in the input image;
generating an image corresponding to each of the objects;
calculating a motion vector of an object within each of the generated images; combining the motion vectors and outputting the combined motion vector as a final motion estimate of the input image.

18. The motion estimation method of claim 1, wherein the objects are separated based on the detected depth information.

19. The motion estimation method of claim 18, wherein the detection of depth information relating to an input image comprises dividing the input image into a plurality of blocks and detecting depth information relating to each of the blocks.

20. The motion estimation method of claim 19, wherein the combining comprises combining the motion vectors of the objects in the generated images based on block matching errors of blocks included within each of the generated images.

21. The motion estimation method of claim 18, wherein the separation of objects included in the input image comprises dividing the plurality of blocks into at least two groups based on the depth information relating to each of the blocks and separating the objects included in the input image according to the at least two groups.

22. The motion estimation method of claim 18, wherein in response to the depth information relating to the input image being received, the depth information detection comprises parsing the received depth information to detect the depth.
